(19) United States
(12) Patent Application Publication
(10) Pub. No.: US 2010/0023408 A1
(43) Pub. Date: Jan. 28, 2010

(54) AUTOMATED CAMPAIGN RECONCILIATION

(76) Inventor: Eileen Mc Neill, Studio City, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/180,041

(22) Filed: Jul. 25, 2008

(51) Int. Cl. G06Q 30/00

(52) U.S. Cl. 705/14.69

(57) ABSTRACT

Systems and methods for automatically changing the rate of web page advertisements served by or on behalf of a publisher based on the number of web page advertisement impressions counted by or on behalf an advertiser are disclosed. By monitoring the number of impressions counted on or behalf of an advertiser the systems and methods can repeatedly determine a new rate for advertisements to be served at. This new rate can be anticipated to cause the number of impressions counted by or on behalf of the advertiser by the end of a contracted period of time to be at least equal to a contracted number of web page advertisement impressions.

### BACKGROUND

Typically, website publishers or persons associated with website publishers manually reconcile differences between the number of web page advertisement impressions counted by an advertiser and the number counted by the publisher.

### SUMMARY OF THE DISCLOSURE

Systems and methods are disclosed herein for automatically changing the rate of web page advertisement impressions based on the number of advertisement impressions that an advertiser counts. In one aspect, a method is disclosed for receiving, for one or more advertisements served by or on behalf of a publisher, a first number of impressions of said one or more advertisements counted by or on behalf of an advertiser in a first period of time, determining a new rate for the publisher to serve the one or more advertisements based on the first number and a contracted number, where the contracted number may be a number of impressions of the one or more advertisements that the publisher contracted to serve in a contracted period of time. The new rate may be anticipated to cause the number of impressions that an advertiser counts by the end of the contracted period of time to be at least equal to the contracted number. The method is further capable of automatically changing the rate of advertisements served to the new rate.

In another aspect, the method of paragraph [0002] may include predicting the number of impressions that the advertiser will count by the end of the contracted period of time based on the first number, the first period of time, and the time remaining in the contracted period of time, and automatically changing the rate of advertisements served to the new rate only if a difference between the contracted number and the predicted number of impressions is greater than a first threshold value. In another aspect, the first threshold value may be ten percent. In another aspect, the first threshold value may be equal to a value associated with one of a plurality of advertisers. In another aspect, the difference may be calculated as a percentage. In another aspect, the method may include automatically generating a first alert if the difference is greater than the first threshold value. In another aspect, the new rate is equal to the following ratio:

$$\frac{P - A}{T - {T}^{′}}$$

where P is the contracted number of impressions that the publisher contracted to serve during the contracted time period T. The variable A is the first number of impressions counted by or on behalf of the advertiser in the first period of time T′.

In another aspect, a method is disclosed for counting a first number of web page advertisement impressions by or on behalf of an advertiser in a first period of time, predicting the number of web page advertisement impressions that will be counted by an advertiser during the contracted period of time as a predicted number of web page advertisement impressions, wherein predicting is based on the first number, comparing the predicted number of web page advertisement impressions to a contracted number of web page advertisement impressions, and automatically changing a rate of advertisements served to a new rate based on the comparing operation. In an aspect, the new rate may be anticipated to cause the number of impressions that an advertiser counts by the end of the contracted period of time to be at least equal to the contracted number of web page advertisement impressions.

In another aspect, a method is disclosed for determining a first rate of web page advertisement impressions for a given one or more advertisements, based on a first number of web page advertisement impressions counted by or on behalf of an advertiser in a first period of time, determining a second rate of web page advertisement impressions for the given one or more advertisements, based on a second number of web page advertisement impressions counted by or on behalf of a publisher in a second period of time, and calculating a first difference between the second number and the first number. If the first difference is greater than a first threshold value, then the method may automatically change the rate of advertisements served based on the first difference. In another aspect, if the first difference is greater than the first threshold value, then the rate of advertisements served may be automatically changed such that by the end of a contracted period of time, the advertiser will have counted the number of web page advertisement impressions equal to a number that the publisher contracted to serve. In another aspect, the first and second periods of time may be the same. In another aspect, if a second difference between the first number and the second number is greater than a second threshold value, then the method may automatically change the rate of advertisements served based on the second difference. In another aspect, the method may automatically generate a second alert if the first difference is greater than a third threshold value.

In another aspect, the method of paragraph [0005] may further include recording a third number of impressions in a first data set, where the third number is the number of impressions counted by or on behalf of the advertiser during the contracted period of time, recording a fourth number of impressions in a second data set, where the fourth number is the number of impressions counted by or on behalf of the publisher during the contracted period of time, calculating a comparison value as the difference between the fourth number and the third number, and modifying the fourth number in the second data set if the comparison value is equal to or greater than a fourth threshold value. In another aspect, modifying may comprise replacing the fourth number in the second data set with the third number.

In another aspect, a system is disclosed that includes a computer readable medium. The computer readable medium may include an advertiser's counts of web page advertisement impressions for one or more advertisements, and contract data including a contracted period of time and a number of advertisements to be served in the contracted period of time. The computer readable medium may be accessible to a new rate determining module for determining the new rate at which advertisements will be served by or on behalf of the advertiser, and a web page advertisement serving rate adjustment module for controlling the rate of web page advertisements served by or on behalf of the advertiser.

In another aspect, a method is disclosed for receiving, for one or more advertisements, a first number of impressions counted by or on behalf of an advertiser in a first period of time; determining a new rate for a publisher to serve the one or more advertisements based on the first number and a contracted number, where the contracted number is a number of impressions of the one or more advertisements that the publisher contracted to serve in a contracted period of time; and automatically changing the rate of advertisements served to the new rate.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the teachings set forth in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of systems and methods described below and are not meant to limit the scope of the disclosure in any manner, which scope shall be based on the claims appended hereto.

FIG. 1 illustrates an embodiment of a method for automatically changing the rate of advertisements served.

FIG. 1b illustrates an embodiment of a method for automatically changing the rate of advertisements as well as automatically generating a first alert.

FIG. 1c illustrates an embodiment of a method for automatically changing the rate of advertisements as well as automatically generating a second alert.

FIG. 1d illustrates an embodiment of a method for automatically changing the rate of advertisements served based on either a first or second threshold value.

FIG. 1e illustrates an embodiment of a method for automatically changing the rate of advertisements served along with automatically modifying a data set associated with the number of impressions that the publisher counts.

FIG. 2 illustrates one embodiment of the method of FIG. 1 including an operation to modify the number of web page advertisement impressions counted during the contracted period of time by or on behalf of the publisher.

FIG. 3 illustrates an embodiment of a method for automatically changing the rate of advertisements served.

FIG. 4 illustrates an embodiment for automatically changing the rate of advertisements served as well as automatically generating a first alert.

FIG. 5 illustrates a method for automatically changing the rate of advertisements served.

FIG. 6 illustrates a system capable of carrying out the methods of this disclosure.

### DETAILED DESCRIPTION

The following definitions of a database, computer-readable media, and computing device will clarify the detailed description that follows the definitions. For the purposes of this disclosure, a database is one or more mass storage devices in which computer data and computer instructions may be stored and from which they may be retrieved. Storage may be volatile (referred to as “caching”) or non-volatile (e.g. storage on a personal computer hard drive or non-volatile random access memory). A mass storage device includes some form of computer-readable media.

Computer-readable media include volatile and non-volatile, removable and non-removable media implemented in any method or technology for storage of information such as computer-readable instructions, data structures, program modules or other data. Computer-readable media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computing device.

A computing device includes a processor and memory for storing and executing program code, data and software. Computing devices may be provided with operating systems that allow the execution of software applications in order to manipulate data. Personal computers, PDAs, wireless devices, cell phones, internet appliances, media players, home theater systems, and media centers are several non-limiting examples of computing devices.

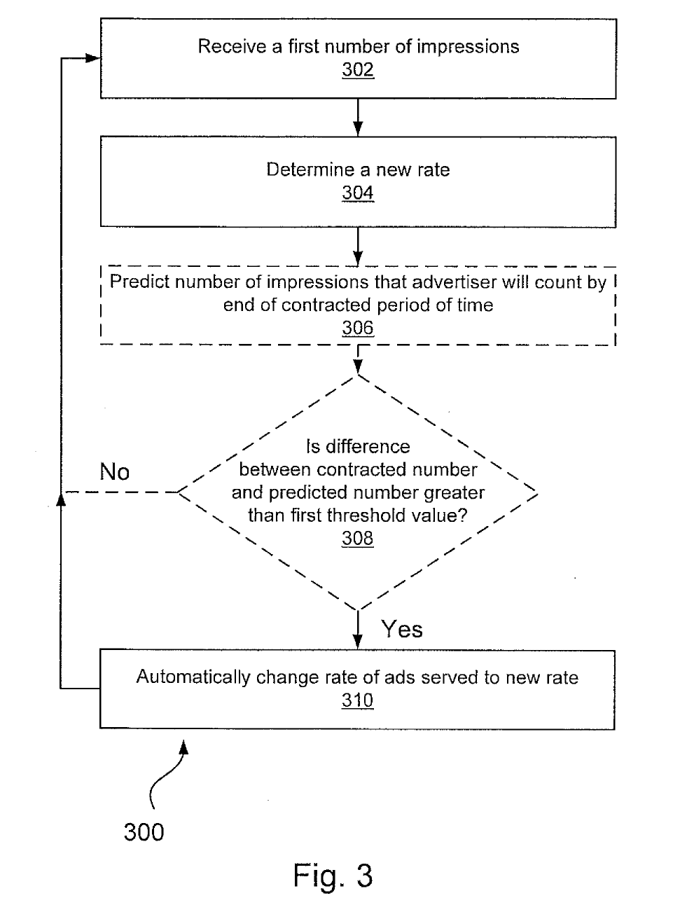

Reference will now be made in detail to the accompanying drawings, which at least assist in illustrating various pertinent embodiments of the present disclosure. FIG. 3 illustrates an embodiment of a method 300 for automatically changing the rate of advertisements served. The method 300 may include an operation for receiving a first number of impressions 302, determining a new rate of advertisements for a publisher to serve 304, and automatically changing the rate of advertisements served to the new rate 310. Optionally, the method 300 may include an operation to predict the number of impressions that an advertiser will count by the end of a contracted period of time 306, and a decision for determining whether a difference between a contracted number of impressions and the predicted number of impressions is greater than a first threshold value 308. In such an embodiment, the rate of advertisements served may only be changed when the difference between the contracted number of impressions and the predicted number of impressions is greater than the first threshold.

An advertiser may monitor the number of advertisements served by a publisher (e.g., advertisement impressions). The publisher may serve these advertisements on web pages that the publisher and advertiser have agreed upon via contract. Such a contract may define one or more advertisements to be served on the agreed-upon one or more web pages, an agreed-upon number of times (the “contracted number” of advertisements), in an agreed-upon period of time (the “contracted period of time”). Via monitoring the served advertisements, the advertiser can count the number of advertisements being served. At the end of the contracted period of time the advertiser expects to have counted a number of served advertisements roughly equal to the number of advertisements that the advertiser paid for and that the publisher agreed to serve. However, the number of advertisement impressions that the advertiser counts may not be equal to or even roughly equal to the number of impressions that the advertiser paid for.

So that the number of advertisement impressions that the advertiser counts more closely reflects the contracted number, the method 300 monitors the number of impressions that an advertiser counts during the contracted period and automatically adjusts the rate of advertisements being served such that the number of impressions that an advertiser counts during the contracted period approaches the contracted number. To do this, the method 300 receives a first number of impressions, for one or more advertisements, that have been counted by or on behalf of an advertiser during a first period of time in a receive a first number of impressions operation 302. In an embodiment, advertisements may be served and impressions of those advertisements counted on one or more web pages. In an embodiment, advertisements may be served and impressions of those advertisements counted on one or more mobile devices (e.g., PDAs, smart phones, cell phones, GPS devices, laptop computers). The first period may include any period of time shorter than the contracted period of time as well as equal to the contracted period of time (e.g., one second, one minute, ten minutes, one hour, one day, one week, or any other period of time). In an embodiment, the first period of time can be selected by the publisher. In an embodiment, the first period of time can be automatically selected. In an embodiment, the first period of time can be fixed or vary in time. For instance, the first period of time can be selected based on the time of day. Evenings and nights may see higher internet traffic then other times of the day and thus the first period of time may be selected to be shorter during evenings and nights. The first number of impressions is communicated by the advertiser (e.g., ad server, advertiser's server, third party working on behalf of the advertiser, other computer system associated with the advertiser), and received by the publisher or a computing system associated with the publisher (e.g., publisher's server, advertisement server).

With the first number of impressions, the method 300 can determine a new rate for serving the one or more advertisements in a determine new rate operation 304. The new rate is derived from the first number of impressions as well as from a second number of impressions. In an embodiment, the second number of impressions is the contracted number. In an embodiment, the new rate is equal to or roughly equal to the rate at which advertisements must be counted by the advertiser in order that the advertiser will have counted the contracted number by the end of the contracted period.

Determination of the new rate can also be performed via more sophisticated means. For instance, in an embodiment, the new rate may be anticipated to cause the number of impressions that an advertiser counts by the end of the contracted period of time to be at least equal to the contracted number. In an embodiment, the new rate may be equal to the following ratio:

$$\frac{P - A}{T - {T}^{′}}$$

where P (the contracted number) is the number of impressions that the publisher contracted to serve during the contracted period of time T, and A (the first number) is the number of impressions that the advertiser has counted during the first period of time T′. This ratio is the rate at which advertisements will need to be served in order that the advertiser will count, at the end of the contracted period of time, the contracted number (assuming the advertiser counts an impression for every advertisement that the publisher serves).

This rate may vary or be fixed. For instance, at the beginning of a contracted time period no advertisements will have been served (A=0) and no time will have elapsed (T′=0). Thus, the ratio will equal (P−0)/(T−0). This is simply the contracted number divided by the contracted time period (P/T) or the average rate of advertisements that the publisher must serve during the contracted period of time in order to serve the contracted number. However, since the advertiser often counts a different number of impressions than the publisher attempts to serve, if the rate P/T is continually used, then the advertiser will often not count the contracted number of advertisements during the contracted period of time. Thus, the new rate may be different than P/T. For instance, one week into a two-week contracted period of time (T′=1 week, T=2 weeks), the denominator of the ratio would be one week (T−T′=1 week). If after this first week the advertiser has counted four hundred impressions (A=400 advertisements), and the publisher contracted to serve one thousand advertisements (P=1000), then the numerator of the ratio will be six hundred advertisements (P−A=600 advertisements), Thus, the ratio, or the new rate, in such an example would be six hundred advertisements per week (600 advertisements/1 week).

In an embodiment, determination of the new rate may account for non-instantaneous calculations. For instance, web page advertisement impressions may be counted at 12:01 pm, and yet the determination may not take place until 12:05 pm due network and computing system requirements. As such, when the determination is made, the time remaining in the contracted period will be four minutes less than if the time remaining were calculated based on the first period of time (which ended at 12:01 pm not 12:05 pm). Thus, the new rate would be calculated factoring in this lapse of four minutes. In another embodiment, determination of the new rate may account for the fact that different numbers of advertisements may be served during different periods of time. For instance, assume that 1000 advertisements are served every weekday, but 2000 advertisements are served each Saturday or Sunday. A first period running from Monday to Wednesday would lead to a determination of the new rate that was likely different than a new rate that was based on a first period running from Friday to Sunday. Thus, determination of the new rate may account for bias that may be caused by the period of time selected for the first period of time.

In an embodiment the rate may be changed repeatedly with any frequency and any period of delay/pause/stoppage between rate changes (e.g., multiple times per second, multiple times per minute, multiple times per hour, multiple times per day).

The method 300 can automatically adjust the rate of advertisements served to match the new rate in an automatically change rate of advertisements served to new rate operation 310. Automatically, is used herein to mean operation generally without human intervention. One exception to this definition is that, in an embodiment, human intervention may be required to encode or modify the computer code from which this method may run.

Once the rate of advertisements served has been automatically changed, the method 300 may begin again with the receive operation 302. Any amount of time or no time may elapse between the change rate operation 310 and the start of the next cycle of the method 300. Furthermore, as the method 300 executes multiple times in a looping fashion, the first period of time may be the same for each loop or may be different. For instance, during times of day in which internet traffic is high, the method 300 may refresh the new rate more often than during low traffic times of day.

Further illustrated in FIG. 3 is an embodiment, in which the automatically change rate of advertisement served to new rate operation 310 is conditional. After a new rate has been determined in the determine new rate operation 304, the method 300 may optionally predict the number of impressions that the advertiser will count by the end of the contracted period of time in a prediction operation 306. Such a prediction may be based on the first number of impressions, the first period of time, and the time remaining in the contracted period of time. For instance, if the advertiser has counted five hundred impressions (the first number) in the first week of a contracted period of time (the first time period), and there are three weeks remaining in the contracted period of time, then the method 300 would predict that the advertiser will have counted 2000 impressions during the contracted period of time (500+3*500). Although this is a simple example of the predicting operation 306, more sophisticated prediction algorithms may also be employed. For instance, if the contracted period of time runs from the Spring into the summer months, where the summer months see higher internet traffic due to student summer vacations, the prediction may take this seasonal fluctuation into account.

Given a predicted number of impressions from the prediction operation 306, the method 300 can optionally determine the difference between the contracted number and the predicted number and ascertain whether this difference is greater than a first threshold value. This ascertainment takes place via decision 308. For instance if the contracted number, is 1000 advertisements, and the predicted number is eight hundred, then the difference is two hundred advertisements. The difference thus roughly forecasts how short of the contracted number of impressions the advertiser will count if the rate of advertisements served does not change. The decision 308 compares this difference to the first threshold value. The first threshold value may be any value that can be compared to in order to determine whether a condition has been met. In an embodiment, the first threshold value is a number. For instance, if the first threshold value is one hundred advertisements, then any difference between the contracted number and the predicted number that is greater than one hundred advertisements will result in an affirmative decision by the decision 308. In an embodiment, the threshold value may be expressed as a percentage (e.g., percentage of impressions, percentage of impressions served, percentage of impressions served in a time period). If the first threshold value is, for example, ten percent, then any difference between the contracted number and the predicted number that is greater than ten percent of the contracted number will result in an affirmative decision by the decision 308.

In one embodiment, the first threshold value may be ten percent. In a similar embodiment, the first threshold value may be a percentage selected from the range zero percent to one hundred percent. In an embodiment, the first threshold value may be equal to a value associated with one of a plurality of advertisers. For instance if advertiser A does more business with a publisher than advertiser B, the method may operate using a first threshold value of five percent when dealing with advertiser A's advertisements and ten percent when dealing with advertiser B's advertisements.

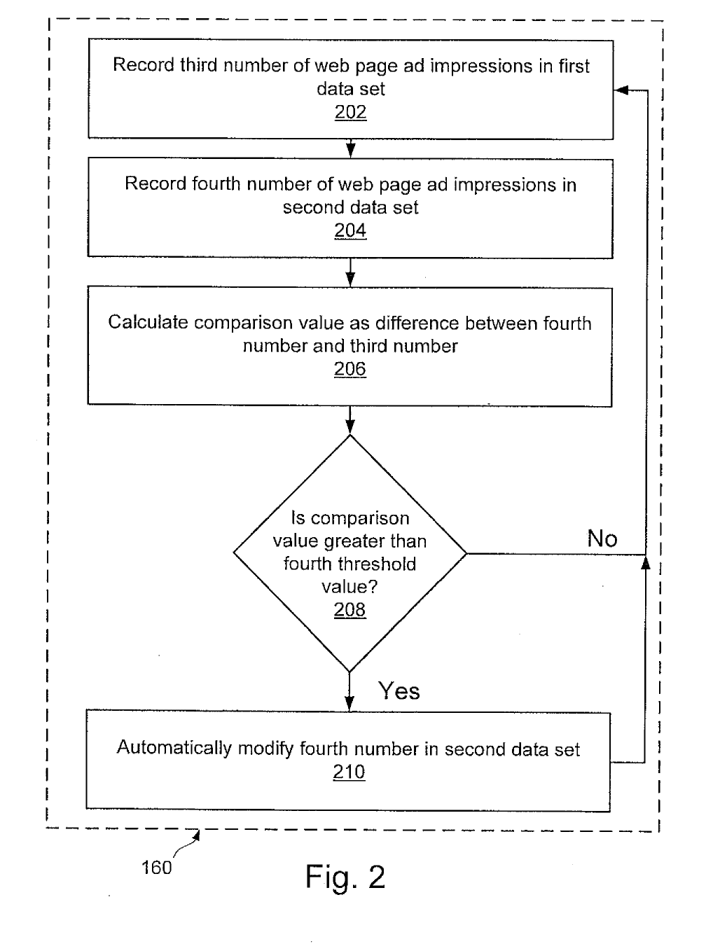

If the difference is greater than the first threshold value, then the method 300 automatically changes the rate of advertisements served to the new rate via the automatically change operation 310. If the difference is not greater than the first threshold value, then the method 300 may end or, after some period of time, begin again with the receive operation 302. Other embodiments may entail different orders of operation than described above and illustrated in FIGS. 2 and 3.

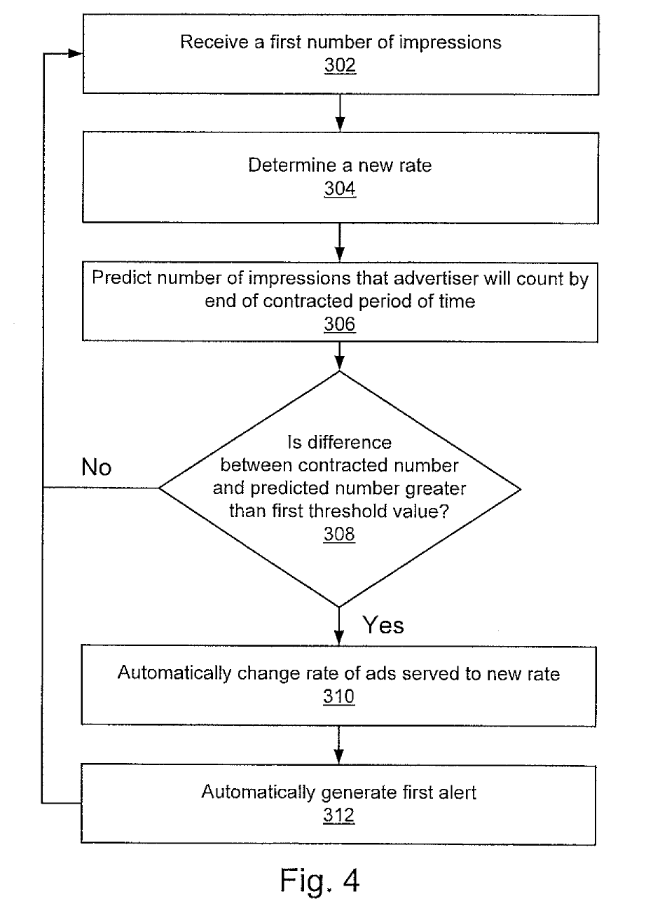

FIG. 4 illustrates an embodiment for automatically changing the rate of advertisements served as well as automatically generating a first alert. In the illustrated embodiment an affirmative answer to the decision 308 initiates the automatically change rate operation 310 and an automatically generate first alert operation 312. The first alert may be a communication with the publisher, a third party associated with the publisher, or a user of the method 300. The first alert may also be a signal/instruction that instructs a computing system to carry out an automated operation in response to the first alert, The first alert may be generated and transmitted autonomously—without human input. After the first alert has been automatically generated, the method 300 may pause/delay/stop for any amount of time and then restart with the determination operation 302. Other embodiments may entail different orders of operation than that entailed in the illustrated embodiment. Each described operation/decision may take different periods of time to execute.

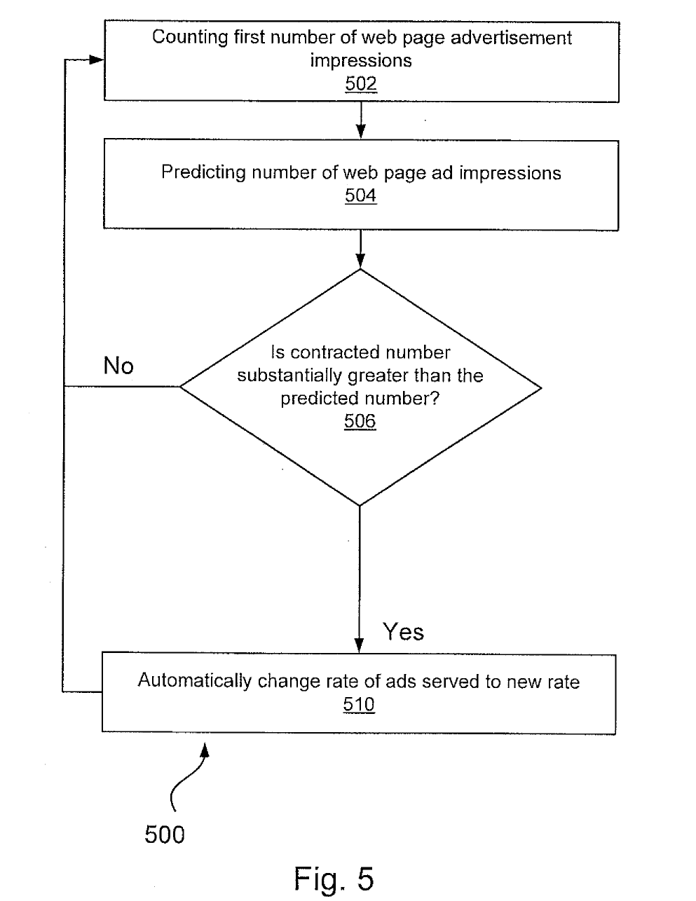

FIG. 5 illustrates a method 500 for automatically changing the rate of advertisements served. The method 500 includes a counting first number of web page advertisement impressions operation 502. In the counting operation 502 an advertiser or a third party associated with the advertiser monitors the number of web page advertisement impressions for the one or more advertisements that the publisher contracted to serve and counts them during the contracted period of time.

The method 500 further includes a predicting the number of web page advertisement impressions operation 504. The prediction operation 504 predicts the number of web page advertisement impressions that will be counted by an advertiser during the contracted period of time. This number may be called the predicted number of web page advertisement impressions. The first number of web page advertisement impressions may be used to predict the number of impressions that will be counted by the advertiser during the contracted period of time. For instance, if the first number is one hundred advertisements, the first period of time is one week, and the contracted period of time is four weeks, then the predicted number of impressions is four hundred advertisements.

The method 500 further includes a comparing the predicted number of web page advertisement impressions to a contracted number of web page advertisement impressions decision 506. Said decision 506 compares the predicted number to the contracted number and if the contracted number is substantially greater than the predicted number, then the method 500 automatically changes the rate of advertisements served via an automatically change rate operation 510. In an embodiment, substantially greater means that the comparison uses a threshold value. In an embodiment, the threshold value can be expressed as a percentage. In such an embodiment, if the difference between the contracted number and the predicted number is greater than the threshold value, then the condition of being substantially greater will be met and the rate will automatically be changed.

The automatically change rate operation 510 may change the rate of advertisements served to a new rate based on the comparing decision 506. “Based on” means that an algorithm or function may be used to derive a factor, used to change the rate, from the comparison decision 506. For instance, in an embodiment, a linear relationship of the comparison and the change in the rate of advertisements served may be used. In an embodiment, the difference between the contracted number and the predicted number may be ten percent of the contracted number. In such an embodiment, the rate of advertisements served may be increased by ten percent.

If there is not a substantial difference between the contracted number and the predicted number, as determined by the comparison decision 506, then the method 500 may begin again. Such restarting of the operation may initiate at any time after the comparison decision 506.

In an embodiment, the automatic change rate operation 510 is anticipated to cause the number of impressions that an advertiser counts by the end of the contracted period of time to be at least equal to the contracted number of web page advertisement impressions.

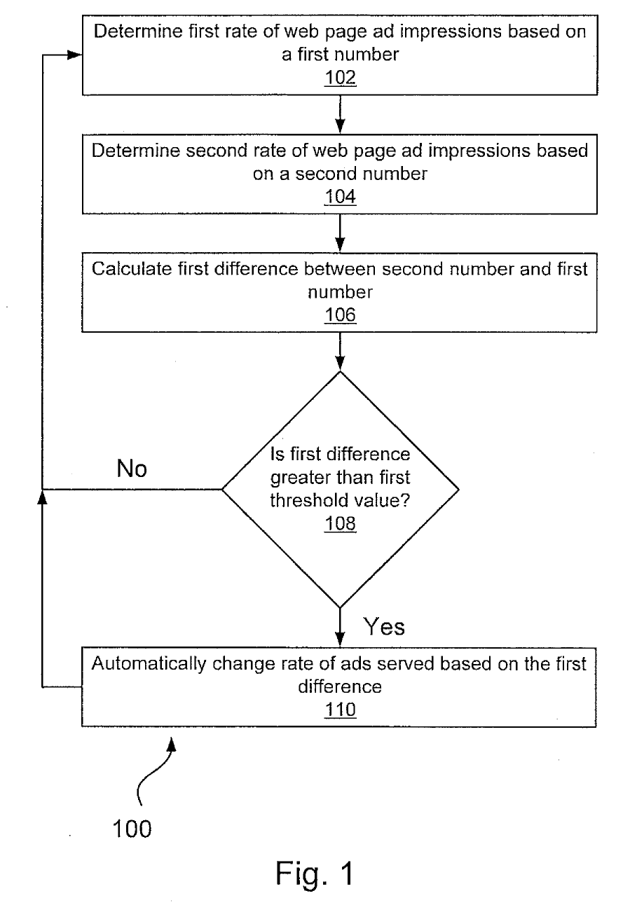

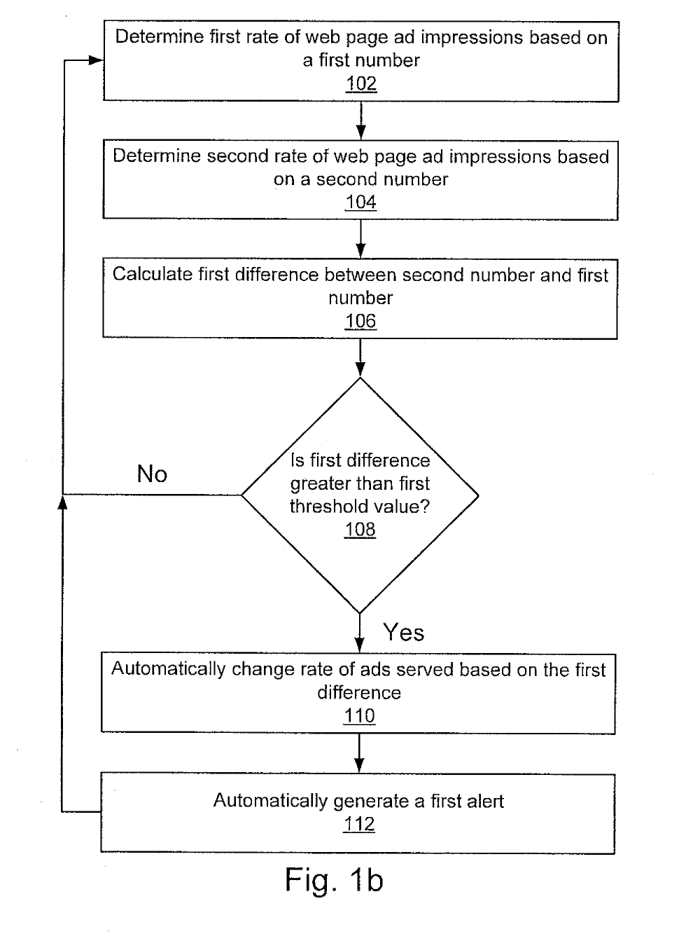

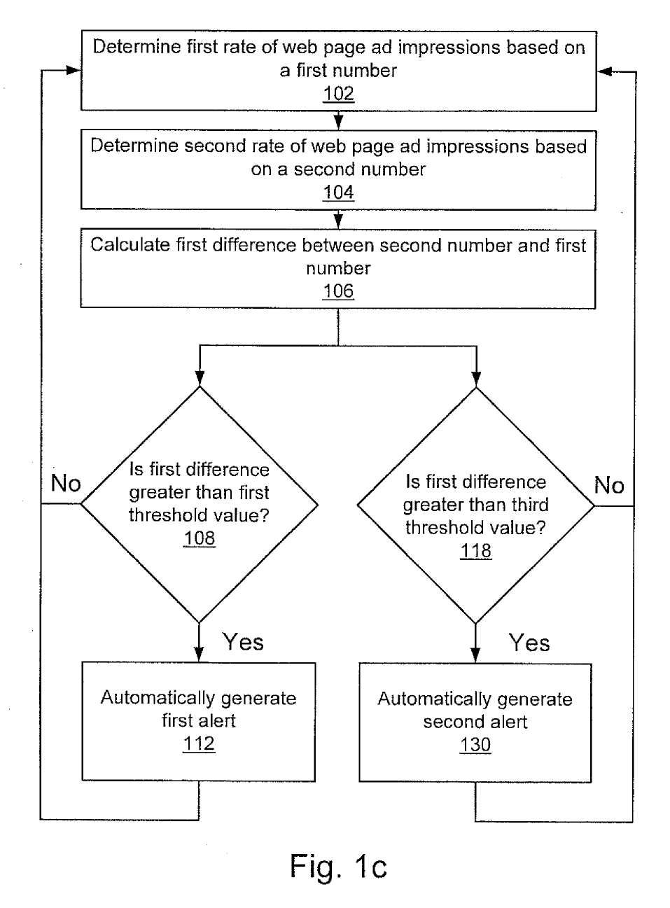

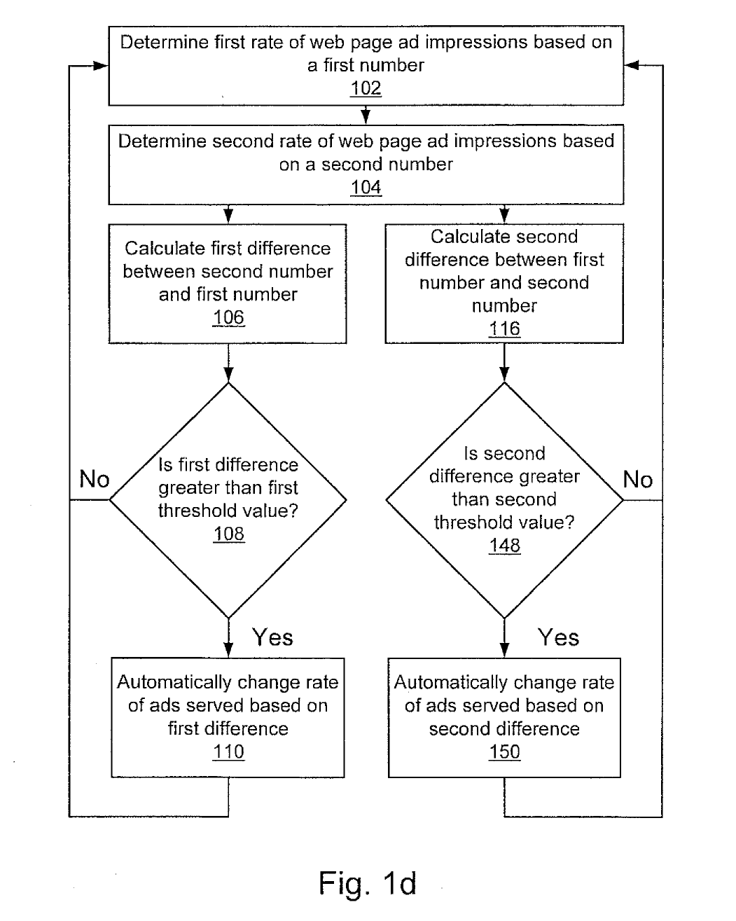

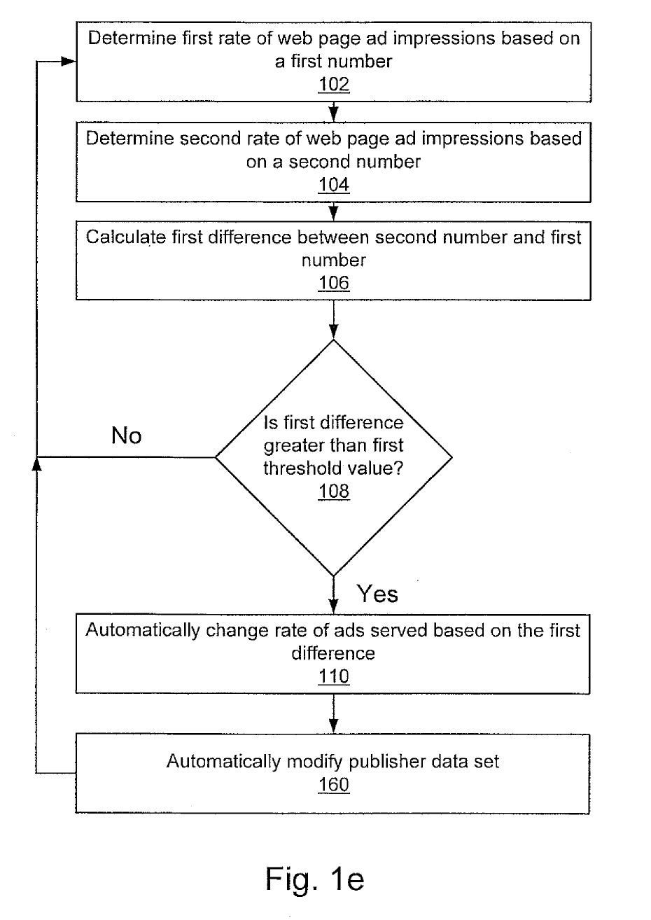

FIG. 1 illustrates a method 100 for automatically changing the rate of advertisements served. The method 100 includes a determine operation 102 in which a first rate of web page advertisement impressions is determined based on a first number. The first number may be the number of web page advertisement impressions counted by or on behalf of an advertiser in a first period of time. Said determination considers impressions that are counted during a first period of time equal to a time period less than or equal to the contracted period of time. The first number of web page advertisement impressions is counted by the advertiser, or may be counted by a third party or other entity working on behalf of the advertiser. The determination is made for one or more advertisements.

The method 100 further includes a determine second rate of web page advertisement impressions operation 104. The determine second rate operation 104 bases the determination on a second number where the second number is a number of web page advertisement impressions counted by or on behalf of a publisher. Said determination considers impressions that are counted during a second period of time equal to a time period less than or equal to the contracted period of time. The second number of web page advertisement impressions is counted by the publisher, or may be counted by a third party or other entity working on behalf of the publisher. The determination is made for one or more advertisements.

The method 100 further includes a calculate a first difference operation 106. The difference calculated in the calculate difference operation 106 is equal to the second number minus the first number. As previously noted, the first number is the number of web page advertisement impressions counted by or on behalf of the advertiser. The second number is the number of web page advertisement impressions counted by or on behalf of the publisher.

The first difference thus gives an indication as to how similar the advertiser and publisher's counts of web page advertisement impressions are. A decision 108 determines whether this first difference is greater than a first threshold value. In an embodiment, the first threshold value can be expressed as a percentage. If the decision 108 determines that the first difference is greater than a first threshold value (e.g., X number of advertisements, X percent), then the rate of advertisements served is automatically changed via an automatically change rate of advertisements served operation 110. The automatically change operation 110 may change the rate based on the first difference. Such a relationship can be one of proportionality (e.g., linear, nonlinear, exponential). If the decision 108 determines that the first difference is not greater than a first threshold value, then the method 100 begins again. Such looping can begin again at any time after the decision 108 completes.

In an embodiment, if the first difference is greater than the first threshold value, the method 100 automatically changes the rate of advertisements served such that by the end of the contracted period of time, the advertiser will have counted the contracted number. In an embodiment, if the first difference is greater than the first threshold value, then the rate of advertisements served may be automatically changed such that by the end of the contracted period of time, the advertiser will have counted the number of web page advertisement impressions equal to a number that the publisher contracted to serve (the contracted number).

In an embodiment, the first and second periods of time are different. For instance the advertiser and publisher may use different time periods over which they count impressions. In another embodiment, the first and second periods of time are the same. By this it is meant that the first and second periods of time are of equal duration and transpire over the same period of time. In another embodiment, the first and second periods of time are equal in duration, but take place over different periods of time.

FIG. 1b illustrates an embodiment for automatically changing the rate of advertisements as well as automatically generating a first alert. In the illustrated embodiment an affirmative answer to the decision 108 initiates the automatically change rate operation 110 and an automatically generate first alert operation 112. These operations 110, 112 may execute simultaneously, at different times, or at overlapping times. The first alert may be communicated to the publisher, a third party associated with the publisher, or a user of the method 100. The first alert may also be a signal/instruction that instructs a computing system to carry out an automated operation in response to the first alert. The first alert may be generated and transmitted autonomously—without human input. After the alert has been automatically generated, the method 100 may pause/delay/stop for any amount of time and then restart with the determination operation 102. Other embodiments may entail different orders of operation than that entailed in the illustrated embodiment. Each described operation/decision may take different periods of time to execute.

Sometimes the difference between the second and first numbers will be so great, that it may be desirable to have a second alert. In the embodiment illustrated in FIG. 10, if the first difference between the second and first numbers is greater than a third threshold, then a second alert may be generated. This second alert may be communicated with more urgency than the first alert. The second alert may be similar or different from the first alert. The third threshold may be greater than the first threshold. For instance if the first threshold is ten percent, then the second threshold may be twenty percent. Thus, the third threshold and second alert are associated with outlier situations where the difference between what the advertiser counts and what the publisher counts are vastly different. As illustrated, if the first difference is greater than the third threshold value, then both the first and second alerts will be generated. However, in an embodiment, when the second alert is generated, the first alert may not be generated since the first alert may be redundant in that situation.

Although the second number is often larger than the first number, in some instances the first number will be larger. In such a situation the first difference will be negative, and clearly the decision 108 will not return an affirmative decision. As such, in the embodiment illustrated in FIG. 1d, a second difference may be calculated as the difference between the first number and the second number in a calculate second difference operation 116. The second difference will be positive where the first difference is negative. If the second difference is greater than a second threshold value, as determined by a decision 148, then the rate of advertisements may be changed based on the second difference rather than on the first difference in an automatically change rate operation 150. In an embodiment, the second difference can be compared to the first threshold value. However, in an embodiment, it may be desirable to have a first and second threshold value—the first threshold value compared against the first difference and the second threshold value compared against the second difference.

FIG. 1e illustrates an embodiment of a method for automatically changing the rate of advertisements served along with automatically modifying a data set associated with the number of impressions that the publisher counts (e.g., publisher data set). This modification may take place in the automatically modify publisher data set operation 160. The modify operation 160 is illustrated in detail in FIG. 2. The operation 160 includes a record third number of web page advertisement impressions in first data set operation 202. As used herein, “record” means to store data on a computer readable medium. The third number may be the number of impressions that the advertiser, or a third party working on behalf of the advertiser, counted during the contracted period of time. The first data set may comprise solely the third number or may comprise the third number and other data. A computer readable medium on which the first data set may be stored may be accessible to the publisher or any other user of the herein-described methods.

The operation 160 also includes a record fourth number of web page advertisement impressions in a second data set operation 204. The fourth number may be the number of impressions that the publisher, or a third party working on behalf of the publisher, counted during the contracted period of time. The second data set may comprise solely the fourth number or may comprise this and other data. In an embodiment, the first and second data sets are recorded on the same computer readable medium. A computer readable medium on which the second data set (or second and first data sets) may be stored may be accessible to the publisher or any other user of the herein-described systems and methods.

The operation 160 also includes a calculate comparison value operation 206. The calculate operation 206 calculates the difference between the fourth number and the third number. In other words, the calculate operation 206 subtracts the number of web page advertisement impressions that the advertiser counted during the contracted period of time from the number of web page advertisements impressions that the publisher counted during the contracted period of time. This difference may be called a comparison value. The comparison value is a measure of how similar or different the number of web page advertisements counted is for the advertiser and publisher. The comparison value can then be used to modify the publisher's data set, the second data set.

For instance, in the illustrated embodiment, the operation 160 also includes a decision 208 in which the comparison value is compared to a fourth threshold value. In an embodiment, the fourth threshold value can be expressed as a percentage. In an embodiment, the fourth threshold value is ten percent. If the decision 208 determines that the comparison value is less than or equal to the fourth threshold value, then the operation 160 begins again after a finite period of time. If the decision 208 determines that the comparison value is equal to or greater than the fourth threshold value (e.g., when the number of web page advertisements counted by the advertiser and publisher are significantly different), then an automatically modify fourth number in second data set operation 210 may execute.

In an embodiment, the modify operation 210 may include replacing the fourth number in the second data set with the third number. In other words replacing the publisher's counts in the publisher's data set with the advertiser's counts. In another embodiment, the modify operation 210 may include changing the fourth number in the second data set to a number related to the third number. After modification, the operation 160 may begin again after a finite period of time. The operation 210 may be automatic thus requiring no human intervention. Such automatic operation eliminates the need for human operators to reconcile advertising campaign data sets with the data recorded and/or provided by advertisers.

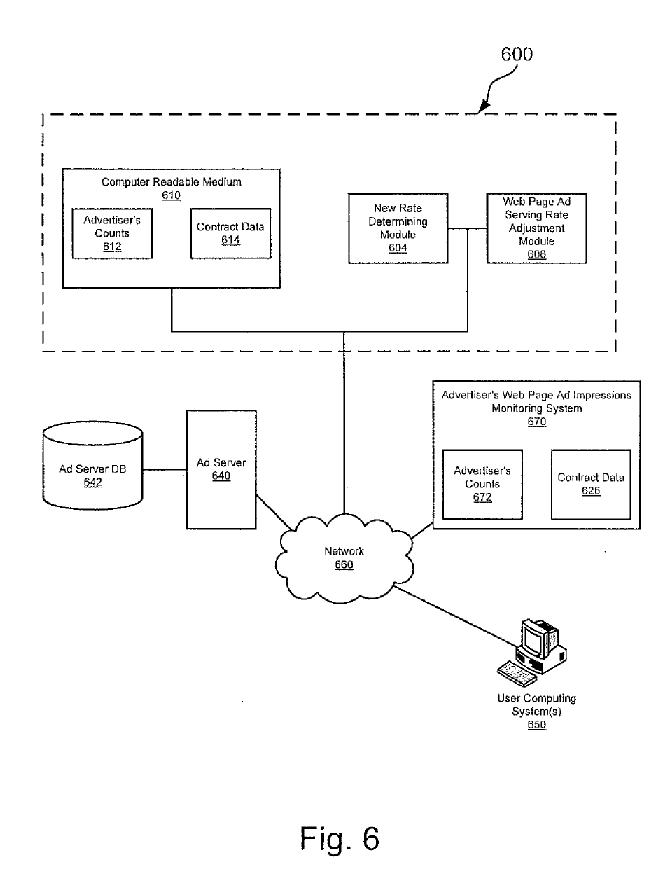

FIG. 6 illustrates a system capable of carrying out the methods of this disclosure. The system 600 comprises a computer readable medium 610. The computer readable medium 610 comprises an advertiser's counts 612 of web page advertisement impressions for one or more advertisements. Along with the advertiser's counts 612, the computer readable medium 610 further comprises contract data 614. The contract data 614 indicates a contracted period of time and a contracted number (the number of advertisements to be served in the contracted period of time). The advertiser's counts 612 is a total number of web page advertisement impressions, for one or more advertisements, that the advertiser counted during the contracted period of time. The advertiser's counts 612 may be recorded on the computer readable medium 610 after the system 600 receives the advertiser's counts 612 from an advertiser's web page advertisement impressions monitoring system 670 or any other system in which the advertiser, or third party working on behalf of the advertiser, monitored and counted the number of web page advertisement impressions.

The computer readable medium 610 may be accessible to a new rate determining module 604 as well as a web page advertisement serving rate adjustment module 606. Both modules 604, 606 may be included in the system 600. Alternatively, one or more of the modules 604, 606 may reside external to the system 600. The new rate determining module 604 may be capable of determining the new rate of web page advertisements that will be served by or on behalf of the advertiser. The new rate determining module 604 may determine this new rate via any number of algorithms. In an embodiment, the new rate is equal to or roughly equal to the rate at which advertisements must be counted by the advertiser in order that the advertiser will have counted the contracted number by the end of the contracted period. In an embodiment, the new rate may be anticipated to cause the number of impressions that an advertiser counts by the end of the contracted period of time to be at least equal to the contracted number. In an embodiment, the new rate may be equal to the following ratio:

$$\frac{P - A}{T - {T}^{′}}$$

where P (the contracted number) is the number of impressions that the publisher contracted to serve during the contracted period of time T, and A (the first number) is the number of impressions that the advertiser has counted during the first period of time T′. This ratio is the rate at which advertisements will need to be served in order that the advertiser will count, at the end of the contracted period of time, the contracted number (assuming that the advertiser counts an impression for every advertisement that the publisher serves).

Given the new rate as determined by the new rate determining module 604, the web page advertisement serving rate adjustment module 606 communicates with a computer system that controls the rate of advertisements that are served. In an embodiment, said computing system is an advertisement server 640. Said advertisement server 640 may be in communication with an advertisement server database 642 in which data associated with advertisements and advertisers is stored. The advertisement server 640 and the system 600 may be in communication via a network 660 (e.g., the Internet). In another embodiment, the system 600 may be in communication with the advertisement server 640 via more than one network. For example, the advertisement server 640 and the system 600 may be in direct communication via a local area network as well as via a more general network such as the Internet.

The web page advertisement serving rate adjustment module 606 may provide computer instructions to the advertisement server 640 that cause the advertisement server 640 to change the rate at which advertisements are served to one or more user computing systems 650. The advertisement server 640 and the one or more user computing systems 650 may be in communication via the network 660.

Not only may the systems and methods herein disclosed reduce costs associated with removing the human element of operation, but they may also enable more rapid modification of the rate of advertisements served than is possible given a human operator. This rapid adaptability may enable publishers to more accurately serve the number of advertisements that an advertiser has contracted for since the system can rapidly compensate for fluctuations in the network that affect the number of impressions that an advertiser counts. In some situations, the number of impressions that the advertiser counts may be so far off from a rate that would enable the advertiser to count the contracted number of impressions during the contracted period that even if the rate of advertisements served is changed, it may not be possible to change the rate enough such that the advertiser will count the contracted number by the end of the contracted period of time. The disclosed systems and methods may be able to change the rate of advertisements served so frequently that the above-described situation may be avoided.

Those skilled in the art will recognize that the systems and methods of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, in an embodiment, the system 600 may be located in the advertisement server 640. Alternatively, in an embodiment, the computer readable medium 610 may reside on one or more advertisement servers 640, and thus be separate from the new rate determining module 604 and the web page advertisement serving rate adjustment module 606.

Numerous other changes may be made that will readily suggest themselves to those skilled in the art and which are encompassed in the spirit of the invention disclosed and as defined in the appended claims.

What is claimed is:

1. A method comprising:
receiving, for one or more advertisements served by or on behalf of a publisher, a first number of impressions of said one or more advertisements counted by or on behalf of an advertiser in a first period of time;
determining a new rate for the publisher to serve the one or more advertisements based on the first number and a contracted number, where the contracted number is a number of impressions of the one or more advertisements that the publisher contracted to serve in a contracted period of time;
wherein the new rate is anticipated to cause the number of impressions that an advertiser counts by the end of the contracted period of time to be at least equal to the contracted number; and
automatically changing the rate of advertisements served to the new rate.

2. The method of claim 1 further comprising:
predicting the number of impressions that the advertiser will count by the end of the contracted period of time based on the first number, the first period of time, and the time remaining in the contracted period of time; and
automatically changing the rate of advertisements served to the new rate only if a difference between the contracted number and the predicted number of impressions is greater than a first threshold value.

3. The method of claim 2 wherein the first threshold value is ten percent.

4. The method of claim 2 wherein the first threshold value is equal to a value associated with one of a plurality of advertisers.

5. The method of claim 2 wherein the difference is calculated as a percentage.

6. The method of claim 2 farther comprising automatically generating a first alert if the difference is greater than the first threshold value.

7. The method of claim 1 wherein the new rate is equal to the following ratio:
$$\frac{P - A}{T - {T}^{′}}$$
where P is the contracted number of impressions that the publisher contracted to serve during the contracted time period T; and
where A is the first number of impressions counted by or on behalf of the advertiser in the first period of time T′.

8. A method comprising:
counting a first number of web page advertisement impressions by or on behalf of an advertiser in a first period of time;
predicting the number of web page advertisement impressions that will be counted by an advertiser during the contracted period of time as a predicted number of web page advertisement impressions, wherein predicting is based on the first number;
comparing the predicted number of web page advertisement impressions to a contracted number of web page advertisement impressions; and
automatically changing a rate of advertisements served to a new rate based on the comparing operation.

9. The method of claim 8 wherein the new rate is anticipated to cause the number of impressions that an advertiser counts by the end of the contracted period of time to be at least equal to the contracted number of web page advertisement impressions.

10. A method comprising:
determining a first rate of web page advertisement impressions for a given one or more advertisements, based on a first number of web page advertisement impressions counted by or on behalf of an advertiser in a first period of time;
determining a second rate of web page advertisement impressions for the given one or more advertisements, based on a second number of web page advertisement impressions counted by or on behalf of a publisher in a second period of time;
calculating a first difference between the second number and the first number; and
if the first difference is greater than a first threshold value, then automatically changing the rate of advertisements served based on the first difference.

11. The method of claim 10 wherein if the first difference is greater than the first threshold value, automatically changing the rate of advertisements served such that by the end of a contracted period of time, the advertiser will have counted the number of web page advertisement impressions equal to a number that the publisher contracted to serve.

12. The method of claim 10 wherein the first and second periods of time are the same.

13. The method of claim 10 wherein if a second difference between the first number and the second number is greater than a second threshold value, then automatically changing the rate of advertisements served based on the second difference.

14. The method of claim 10 further comprising automatically generating a second alert if the first difference is greater than a third threshold value.

15. The method of claim 10 further comprising:
recording a third number of impressions in a first data set, where the third number is the number of impressions counted by or on behalf of the advertiser during the contracted period of time;
recording a fourth number of impressions in a second data set, where the fourth number is the number of impressions counted by or on behalf of the publisher during the contracted period of time;
calculating a comparison value as the difference between the fourth number and the third number; and
modifying the fourth number in the second data set if the comparison value is equal to or greater than a fourth threshold value.

16. The method of claim 15 wherein modifying comprises replacing the fourth number in the second data set with the third number.

17. A system comprising:
a computer readable medium comprising:
an advertiser's counts of web page advertisement impressions for one or more advertisements; and
contract data including a contracted period of time and a number of advertisements to be served in the contracted period of time;
wherein the computer readable medium is accessible to:
a new rate determining module for determining the new rate at which advertisements will be served by or on behalf of the advertiser; and
a web page advertisement serving rate adjustment module for controlling the rate of web page advertisements served by or on behalf of the advertiser.
